(19) United States
(12) Patent Application Publication
(10) Pub. No.: US 2008/0170000 A1
(43) Pub. Date: Jul. 17, 2008

(54) DRIVING METHOD AND APPARATUS OF PLASMA DISPLAY PANEL

(75) Inventor: Byeongseon MIN, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/971,378

(22) Filed: Jan. 9, 2008

(30) Foreign Application Priority Data
Jan. 11, 2007 (KR) 2007-3425

(51) Int. Cl. G09G 3/28

(52) U.S. Cl. 345/60

(57) ABSTRACT

A driving method and apparatus of a plasma display panel prevents a low discharge and an over discharge from occurring in a sustain period of a following sub-field by gradually changing a rising time of a last sustain pulse applied in the sustain period in each sub-field. The driving method includes dividing one frame into a plurality of sub-fields, each sub-field respectively including a reset period, an address period, and a sustain period, wherein a rising time of a last sustain pulse applied in the sustain period is gradually changed in each sub-field.

### CROSS-REFERENCE TO RELATED APPLICATIONS

This application claims the benefit of Korean Application No. 2007-3425, filed Jan. 11, 2007, in the Korean Intellectual Property Office, the disclosure of which is incorporated herein by reference.

### BACKGROUND OF THE INVENTION

1. Field of the Invention

Aspects of the present invention relate to a driving method and apparatus for a plasma display panel.

2. Description of the Related Art

A plasma display panel (hereinafter “PDP”) is formed by tightly sealing two substrates that face each other and injecting a discharge gas into a discharge space between the facing substrates. The PDP displays an image using visible rays emitted from a phosphor that is excited by ultraviolet rays generated from plasma that is obtained through the gas discharge. The PDP is used for a plasma display device, i.e., a flat panel display (FPD).

The PDP uses a method for dividing and driving one frame into a plurality of sub-fields so as to display a gray scale required for image display. The respective subfields are divided into a reset period so as to uniformly generate a discharge, an address period to select a discharge cell, and a sustain period to display a gray scale according to a weight value. For example, if an image with 256 gray scales is selected, one frame period (16.67 ms) corresponding to 1/60 second is divided into 8 sub-fields. In this time, 8 sub-fields are respectively divided into the reset period, the address period, and the sustain period again. The reset period and the address period are selected as same as in each sub-fields, while the sustain period is increased at a ratio of 2ⁿ (provided n=0, 1, 2, 3, 4, 5, 6 and 7) in the respective sub-fields. Further, the respective sub-fields display a gray scale of the PDP by changing the number of sustain pulses applied during the sustain period.

For the reset period of the respective sub-fields all discharge cells are initialized, and for the address period an on-discharge cell (i.e., a discharge cell in which a discharge is to occur) and an off-discharge cell (i.e., a discharge cell in which no discharge is to occur) are selected. During the sustain period a sustain pulse is applied to the selected on-discharge cells, thereby maintaining the discharge.

Conventionally, if a sub-field that displays a high gray scale using the relatively large number of sustain pulses is completed, a relatively large number of wall charges exist inside a discharge cell. Accordingly, for a reset period of a next sub-field, a stronger reset discharge than a desired discharge occurs, and a large number of wall charges are erased so that the address discharge applied during an address period is unstable. Accordingly, for a following sustain period a sustain discharge may be generated as a low discharge.

If a sub-field that displays a low gray scale is completed, a relatively small number of wall charges exist inside the discharge cell. Accordingly, for a reset period of a next sub-field, a weaker reset discharge than a desired discharge occurs, and the small number of wall charges is erased so that an address discharge may be wrongly discharged due to more wall charges than those necessary for an address period. Therefore, there is a problem that the sustain discharge is strongly generated for the following sustain period resulting in an over discharge.

### SUMMARY OF THE INVENTION

Accordingly, an aspect of the present invention is to provide a driving method and apparatus of a PDP that can prevent a low discharge and an over discharge from being generated for a sustain period of a next sub-field by gradually changing a rising time of a last sustain pulse applied during a sustain period in each sub-field.

According to an aspect of the present invention, there is provided a driving method of a PDP, which includes: dividing one frame into a plurality of sub-fields, respectively including a reset period, an address period and a sustain period, wherein a rising time of a last sustain pulse applied in the sustain period differs in each sub-field.

According to an aspect of the present invention, the rising time of the last sustain pulse may be selected to be shorter if each sub-field has a relatively lower gray scale weight value.

According to an aspect of the present invention, the rising time of the last sustain pulse may be in proportion, respectively, to the number of sustain pulses applied in the sustain period of each of the sub-fields.

According to an aspect of the present invention, the sub-field may be divided so as to increase a gray scale from a low level to a high level.

According to another aspect of the present invention, there is provided a driving method of a PDP, which may include: dividing one frame into a plurality of sub-fields, respectively including a reset period, an address period, and a sustain period, in which a rising time of a last sustain pulse applied in the sustain period differs from respective sub-fields due to a temperature or a peripheral temperature of the PDP.

According to an aspect of the present invention, the rising time of the last sustain pulse may be selected to be short if the temperature or the peripheral temperature of the PDP is lower than a reference temperature, the rising time may be selected to be long if the temperature and the peripheral temperature of the PDP is higher than the reference temperature, and the rising time may be selected to be the same if the temperature and the peripheral temperature of the PDP is the same as the reference temperature.

According to still another aspect of the present invention, there is provided a driving apparatus of a PDP including a plurality of first electrodes, a plurality of second electrodes, and a plurality of address electrodes, the driving apparatus including a controller to divide one frame into a plurality of sub-fields, and to drive by time-dividing the sub-fields into a reset period, an address period, and a sustain period; and a driver to apply a sustain pulse to the first and second electrodes in the sustain period, wherein the rising time of the last sustain pulse applied in the sustain period differs from each sub-field.

According to an aspect of the present invention, the driving apparatus of the PDP may further include a temperature sensor to measure a temperature of the PDP or a peripheral temperature thereof.

According to an aspect of the present invention, the controller may select the rising time of the last sustain pulse to be short if a temperature measured by the temperature sensor is lower than a reference temperature, may select the rising time of the last sustain pulse to be long if the temperature is higher than the reference temperature, and may select the rising time of the last sustain pulse to be the same if the temperature and the peripheral temperature of the PDP is the same as the reference temperature.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram illustrating a structure of a plasma display panel according to an exemplary embodiment of the present invention;

FIG. 2 is a block diagram conceptually illustrating a driving device of a plasma display panel according to an exemplary embodiment of the present invention;

FIG. 3 is a diagram illustrating a driving pulse applied to the plasma display panel according to an exemplary embodiment of the present invention;

FIG. 4 is a block diagram conceptually illustrating a driving device of a plasma display panel according to an exemplary embodiment of the present invention; and

FIG. 5 is a flow chart sequentially illustrating a driving method of the plasma display panel according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain aspects of the present invention by referring to the figures.

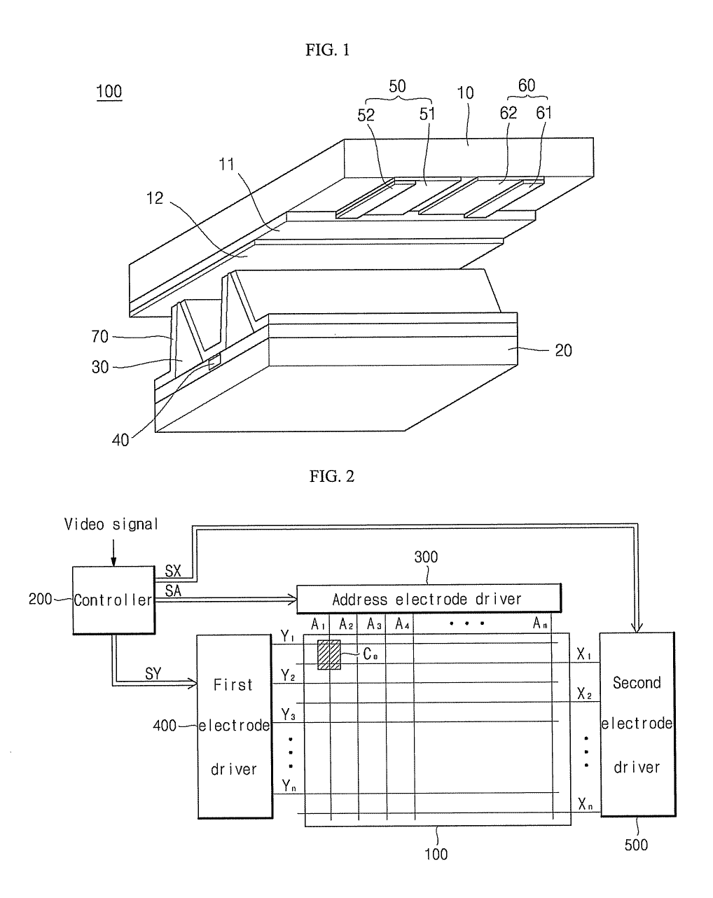

FIG. 1 is a schematic diagram illustrating a structure of a plasma display panel (PDP) according to an exemplary embodiment of the present invention. Referring to FIG. 1, the PDP 100 includes upper and lower substrates 10 and 20 that face each other and are spaced apart from each other, barrier ribs 30 arranged between the upper and lower substrates 10 and 20, an address electrode 40 arranged on the lower substrate 20 in a direction parallel to the barrier rib 30, first and second electrodes 50 and 60 arranged in a direction that intersects the address electrode 40 and alternately formed on a lower surface of the upper substrate 10, and a phosphor layer 70 coated on the barrier ribs 30.

The PDP 100 is formed with the upper substrate 10 made of a transparent material, such as glass, having a predetermined thickness and the lower substrate 20. On the upper substrate 10, the first and second electrodes 50 and 60 arranged in parallel on a surface facing to the lower substrate 20, an upper dielectric layer 11 disposed so as to cover the first and second electrodes 50 and 60, and a MgO protection layer 12 are sequentially formed. On the upper dielectric layer 11, wall charges generated from discharge are accumulated. The MgO protection layer 12 increases an emission efficiency of a secondary electron and prevents the upper dielectric layer 11 from being damaged by the sputtering of charged particles during the discharge.

The lower substrate 20 may be formed of the same material as the upper substrate 10. On an upper surface of the lower substrate 20, the address electrode 40 is formed and a lower dielectric layer 21 is disposed so as to cover the address electrode 40. On an upper surface of the lower dielectric layer 21, the barrier ribs 30 are formed. The phosphor layer 70 is coated on the lower dielectric layer 21 and the barrier ribs 30. The barrier ribs 30 have a fixed height so as to separate the phosphor layer 70 therein from the phosphor layer 70 disposed in a neighboring discharge cell on the upper surface of the lower substrate 20. The barrier ribs 30 are formed in a stripe type, but the barrier ribs 30 are not limited thereto. The barrier ribs 30 may be formed in various types, such as the stripe type, a matrix type, and the like.

The address electrode 40 is arranged parallel to the barrier ribs 30 at an interval corresponding to an interval of a discharge cell. The address electrode 40 is disposed on the upper surface of the lower substrate 20 in a direction that intersects the first and second electrodes 50 and 60. The address electrode 40 is arranged so as to pass through an approximate center of the discharge cell. Further, the address electrode 40 is disposed along the bottom of the discharge cell as defined by the barrier ribs 30 and the first and second electrodes 50 and 60. Moreover, the address electrode 40 is not limited thereto such that there may be a plurality of address electrodes 40 arranged in parallel and respectively corresponding to a plurality of discharge cells as defined by the barrier ribs 30 and pluralities of the first and second electrodes 50 and 60.

The first and second electrodes 50 and 60 are alternately formed on the lower surface of the upper substrate 10 in a direction that intersects the address electrode 40. The first and second electrodes 50 and 60 respectively include transparent electrodes 51 and 61, and metal electrodes 52 and 62 to compensate for resistances of transparent electrodes 51 and 61.

A discharge gas (for example, a mixed gas including xenon (Xe), neon (Ne), and the like) is injected inside the discharge cell of the PDP 100.

A plasma display device to which the PDP 100 is applied will be explained below. FIG. 2 is a block diagram illustrating a driving device of a PDP according to an exemplary embodiment of the present invention. Referring to FIG. 2, the driving device of the PDP includes a controller 200, an address electrode driver 300, a first electrode driver 400, and a second electrode driver 500.

The PDP 100 includes a plurality of address electrodes (A1, A2, . . . , Am) arranged in a column direction, a plurality of first electrodes (Y1, Y2, . . . , Yn) and a plurality of second electrodes (X1, X2, . . . , Xn) that are alternately arranged in a row direction. A discharge cell (Ce) corresponding to a unit pixel of the PDP 100 is formed at a point where on of each of the plurality of first electrodes (Y1, Y2, . . . , Yn), the plurality of second electrode (X1, X2, . . . , Xn), and the plurality of address electrodes (A1, A2, . . . , Am) intersect.

The controller 200 receives a video signal from a source and generates a control signal (SA) to drive the plurality of address electrodes (A1, A2, . . . , Am) and transmits the control signal (SA) to the address electrode driver 300. The controller 200 also generates control signals (SY and SX) to drive the plurality of first electrodes (Y1, Y2, . . . , Yn) and the plurality of second electrode (X1, X2, . . . , Xn), which are respectively transmitted to the first and second electrode drivers 400 and 500. Further, the controller 200 divides one frame into a plurality of sub-fields each having a gray scale weight value and divides each sub-field into a reset period, an address period, and a sustain period, respectively, so as to perform a time division.

The address electrode driver 300 includes a plurality of driving circuits to receive the control signal (SA) from the controller 200 and to apply a driving pulse to the address electrodes (A1, A2, . . . , Am). The first electrode driver 400 includes a plurality of driving circuits to receive the control signal (SY) from the controller 200 and to apply a driving pulse to the first electrode (Y1, Y2, . . . , Yn). The second electrode driver 500 includes a plurality of driving circuits to receive the control signal (SX) from the controller 200 and to apply a driving pulse to the second electrodes (X1, X2, . . . , Xn).

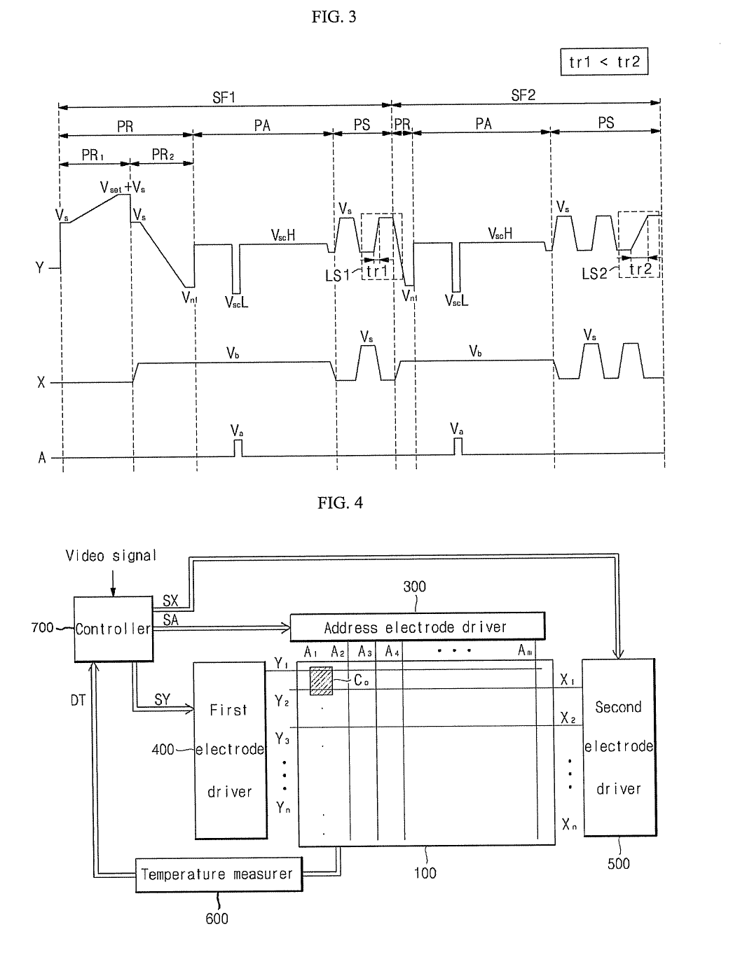

A driving method of a PDP according to an exemplary embodiment of the present invention will be explained below. FIG. 3 is a diagram illustrating a driving pulse applied to the PDP by the driving method of the PDP according to an exemplary embodiment of the present invention. Hereinafter, it will be explained on the basis of a discharge cell formed by one first electrode (hereinafter “Y electrode”), one second electrode (hereinafter “X electrode”), and one address electrode (hereinafter “A electrode”). The term “wall charge” means a charge formed adjacent to respective electrodes on a wall of a cell (for example, on a dielectric layer). The wall charge is need not contact the electrode itself. The wall charge is described as “formed” on an electrode, “accumulated,” or “stacked”. Further, only two of the plurality of sub-fields is shown in FIG. 3. The two sub-fields will be explained as a first sub-field (SF1) and a second sub-field (SF2). The first sub-field (SF1) represents a sub-field having the lowest gray scale weight value among a plurality of sub-fields, and the second sub-field (SF2) represents a sub-field having a higher gray scale weight value than that of the first sub-field.

Referring to FIG. 3, the first sub-field (SF1) and the second sub-field (SF2) each include a reset period (PR), an address period (PA), and a sustain period (PS). The sustain period (PS) of the first sub-field (SF1) includes a rising time trl and a last sustain pulse LS1 applied to the Y electrode. The sustain period (PS) of the second sub-field (SF2) includes a rising time tr2 and a last sustain pulse LS2 applied to the Y electrode. The rising times tr1 and tr2 are changeable.

Aspects of the present invention use a selective reset method. In the reset period (PR) of the first sub-field (SF1), a main reset pulse including a reset rising period (PR₁) and a reset falling period (PR₂) is applied to the Y electrode. In the reset period (PR) of the following sub-field including the second sub-field (SF2), an auxiliary reset pulse is applied. However, the reset period (PR) may include various types of reset pulses such that the reset pulses used according aspects of the present invention and the main reset pulse may be applied without the auxiliary reset pulse, but aspects of the present invention are not limited thereto.

For the reset rising period (PR1) of the first sub-field (SF1), while an X electrode and an A electrode are maintained at 0V, a rising pulse that increases a voltage Vs by a voltage Vset is applied to a Y electrode (i.e., the voltage applied to the Y electrode increases from Vs to Vs+Vset. Accordingly, while a weak reset discharge occurs between the Y and X electrodes and between the Y and A electrodes, wall charges of a negative polarity are accumulated on the Y electrode and wall charges of a positive polarity are accumulated on the X and A electrodes.

For the reset falling period (PR2) of the first sub-field (SF1), while the X and A electrodes are maintained respectively at a Voltage Vb and 0V, a falling pulse is applied to the Y electrode and decreases the voltage applied to the Y electrode from the voltage Vs to a voltage Vnf. Accordingly, while a weak reset discharge occurs between the Y and X electrodes and between the Y and A electrodes, the wall charges of the negative polarity accumulated on the Y electrode are erased and the wall charges of the positive polarity accumulated on the X and A electrodes are erased. A wall voltage due to the wall charges is formed adjacent to a firing voltage. The main reset pulse, including the rising and falling pulses, is applied to all discharge cells at the same time so as to rearrange the wall charge to an initialization status.

For the address period (PA) of the first sub-field (SF1), while the X electrode is maintained at the Voltage Vb, a scan pulse having a voltage VscL and an address pulse having a Voltage Va are respectively applied to the Y and A electrodes, so that a discharge cell to be discharged for the sustain period (PS) is selected. The scan pulse having a voltage VscL is a pulse with respect to a voltage VscH applied to the Y electrode, the voltage VscH being higher than the voltage VscL. An address discharge occurs according to a voltage difference (Va−VscL) between the Y and A electrodes and the wall voltage due to the wall charge, so that the wall charges of the positive polarity are accumulated on the Y electrode and the wall charges of the negative polarity are accumulated on the A and X electrodes.

For the sustain period (PS) of the first sub-field (SF1), while the A electrode is maintained at 0V, a sustain pulse having the voltage Vs on the Y and X electrodes is alternately applied. A sustain discharge occurs due to a voltage difference (Vs) between the Y and X electrodes and the wall voltage generated in the address period (PA). If the last sustain pulse (LS1) is applied in the sustain period (PS) of the first sub-field (SF1), the wall charges of a negative polarity are formed on the Y electrode and the wall charges of a positive polarity are formed on the X and A electrodes. The number of the sustain pulses applied to the X and Y electrodes is determined according to a gray scale weight value of the sub-field. Accordingly, in the first sub-field (SF1) the lowest number of sustain pulses is applied among the plurality of sub-fields as the first sub-field (SF1) has the lowest gray scale weight value among a plurality of sub-fields.

In the sustain period (PS) of the first sub-field (SF1), the rising time (tr1) of the last sustain pulse (LS1) is controlled so as to not produce an over discharge for the sustain period (PS) of the following sub-field. i.e., the second sub-field (SF2). Particularly, the number of the sustain pulses applied in the sustain period (PS) of the first sub-field (SF1) is relatively lower than the number of the sustain pulses applied in the sustain period (PS) of the second sub-field (SF2) so that a relatively smaller number of wall charges is formed inside the discharge cell when the sustain period (PS) of the first sub-field (SF1) is completed. Accordingly, the rising time (tr1) of the last sustain pulse (LS1) of the first sub-field (SF1) is shorter than the second sub-field (SF2) so that the volume of the wall charge is supplemented. If the rising time (tr1) of the last sustain pulse (LS1) of the first sub-field (SF1) is selected to be short, a relatively large number of wall charges is generated after completion of the first sub-field (SF1) so that a reset discharge is relatively strong in the reset period (PR) of the second sub-field (SF2) and the relatively large number of wall charges is erased. Accordingly, for the address period (PR) of the second sub-field (SF2), an address discharge is normally performed, thereby preventing an over discharge from being generated for the sustain period (PS) of the second sub-field (SF2).

If the sustain period (PS) of the first sub-field (SF1) is completed, the second sub-field (SF2) is initiated. For the reset period (PR) of the second sub-field (SF2), while the X and A electrodes are maintained respectively at the voltage Vb and 0V, an auxiliary reset pulse that decreases the voltage applied to the Y electrode from the voltage Vs to a Voltage Vnf. While a sustain discharge occurs for the sustain period (PS) of the first sub-field (SF1), the wall charges of the negative polarity are accumulated on the Y electrode and the wall charges of the positive polarity are accumulated on the X and A electrodes. Accordingly, while the auxiliary reset pulse is applied, a weak discharge occurs inside the discharge cell respectively between the Y and X electrodes and between the Y and A electrodes so that the wall charges of the Y, X, and A electrodes are initialized.

If the sustain discharge does not occur for the sustain period (PS) of the first sub-field (SF1), the wall charge of the discharge cell is maintained in a state that is the same as that of the discharge cell just after the reset period (PR) of the first sustain period (PS) of the first sub-field (SF1). Accordingly, the wall voltage due to the wall charge is formed in the discharge cell adjacent to the firing voltage, so that the discharge does not occur for the reset period (PR) of the second sub-field (SF2) to which the auxiliary reset pulse is applied.

For the address period (PA) of the second sub-field (SF2), the same pulse as the first sub-field (SF1) is applied so as to select a discharge cell to be discharged for the sustain period (PS).

While the A electrode is maintained at 0V for the sustain period (PS) of the second sub-field (SF2), a sustain pulse having the voltage Vs is applied alternately to the Y and X electrodes. The sustain discharge occurs due to a voltage difference equal to the voltage Vs between the Y and X electrodes and the wall voltage due to the wall charge generated for the address period (PA). The second sub-field (SF2) has a relatively high gray scale weight value in comparison with the first sub-field (SF1) such that a large number of sustain pulses are applied to the X and Y electrodes for the sustain period (PS) in comparison with the sustain period (PS) of the first sub-field (SF1).

In the sustain period (PS) of the second sub-field (SF2), the rising time (tr2) of the last sustain pulse (LS2) is controlled so as to not produce a low discharge for the sustain period (PS) of the following sub-field, that is, a third sub-field (not shown). Particularly, a number of sustain pulses applied in the sustain period (PS) of the second sub-field (SF2) is relatively large in comparison to the first sub-field (SF1), so that a large number of wall charges is formed inside the discharge cell when the sustain period (PS) is completed. Accordingly, the rising time (tr2) of the last sustain pulse (LS2) is increased in comparison to the rising time (tr1) of the last sustain pulse (LS1) of the first sub-field (SF1) so that the number of wall charges is decreased. Accordingly, for the reset period (PR) of the third sub-field, a relatively weak discharge is generated and a relatively small number of wall charges remain inside the discharge cell when the reset period (PR) of the third sub-field is completed so that the address discharge is normally performed for the address period (PA) of the third sub-field. Accordingly, the low discharge does not occur for the sustain period (PS) of the third sub-field.

According to the driving method of the PDP, if the PDP is driven by dividing one frame into n number (n indicates a natural number more than 1) of sub-fields, the rising time of the last sustain pulse applied in the sustain period of each sub-field is gradually changed in each sub-field. n number of sub-fields are arranged so as to sequentially increase a gray scale from a low level to a high level. If the number of sub-fields from the first to nth sub-field is increased, the rising time of the last sustain pulse applied in the sustain period decreases. If the sub-field has the high gray scale weight value, the number of sustain pulses applied in the sustain period is increased, i.e., a sub-field will have a higher gray scale weigh value than a previous sub-field. As the number of sustain pulses increases, the number of wall charges at completion of the sustain discharge is also increased. Accordingly, it is understood that the rising time of the last sustain pulse applied in the sustain period increases in proportion to the number of the sustain pulses applied in the sustain period of the respective sub-fields.

The rising time of the sustain pulse determines the intensity of the sustain discharge and the number of wall charges. The rising time of the last sustain pulse is described as short or long with respect to the sustain pulses previously applied in the sustain period. The rising time is relatively short, a firing time becomes faster and the volume of wall charge accumulated inside the discharge cell also becomes larger. Accordingly, if the last sustain pulse having a relatively short rising time is applied to the sub-field having a relatively low gray scale weight value, a relatively large number of wall charges is formed at completion of the sub-field so that the reset discharge occurs relatively strongly for the reset period of the next sub-field and the large volume of wall charges is erased. Accordingly, after completion of the reset discharge, the wall charge necessary for the address discharge is normally formed in the address period so that an over discharge does not occur in the following sustain period.

On the contrary, if the rising time becomes relatively longer, the firing time becomes slower and the number of wall charges accumulated inside the discharge cell becomes smaller. Accordingly, if the last sustain pulse, of which the rising time is relatively longer, is applied to the sub-field having a relatively high gray scale weight value, the relatively small volume of wall charges is formed at the completion of the sub-field, the reset discharge occurs relatively weakly for the reset period of the next sub-field and the small volume of wall charges is erased. Consequently, after completion of the reset discharge, the wall charge required for the address discharge for the address period is normally formed, so that a low discharge does not occur in the following sustain period.

The last sustain pulse is applied to the Y electrode, but the last sustain pulse is not limited thereto, and the last sustain pulse may be applied to the X electrode according to a driving pulse. In such case, the rising time of the last sustain pulse applied to the X electrode may be gradually changed in each sub-field.

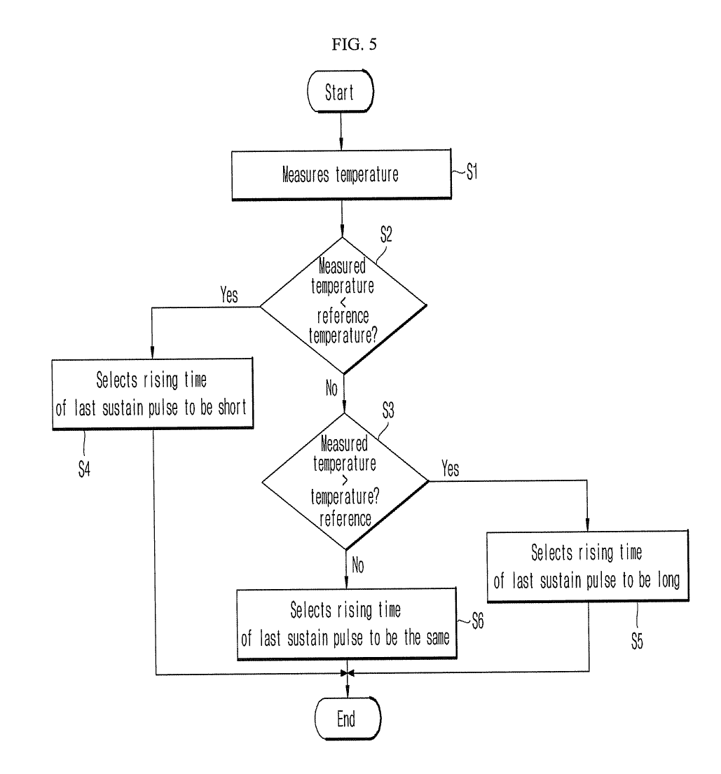

A driving device and method of the PDP according to an exemplary embodiment of the present invention will be explained. FIG. 4 is a block diagram illustrating a driving device of the PDP according to an exemplary embodiment of the present invention. FIG. 5 is a flow chart sequentially illustrating a driving method of the PDP according to an exemplary embodiment of the present invention. Referring to FIG. 4, the driving device of the PDP includes a controller 700, an address electrode driver 300, a first electrode driver 400, a second electrode driver 500, and a temperature sensor 600.

The driving device of the PDP is similar to the driving device of the above-described the PDP except for the temperature sensor 600 and the controller 700.

The temperature sensor 600 measures a temperature of the PDP and peripheral parts and transmits the measured temperature data (DT) to the controller 700. The controller 700 respectively selects a different rising time of the last sustain pulse applied in the sustain period according to the transmitted temperature data (DT).

Referring to FIG. 5, the driving method of the PDP measures a temperature S1, compares the measured temperature S2 and S3, and determines a rising time of the last sustain pulse according to the measured temperature S4, S5, and S6.

In the temperature measuring operation S1, a temperature of the PDP 100 and its peripheral parts is measured. The temperature comparing operations S2 and S3 compare whether the measured temperature is higher than a reference temperature. If the measured temperature is lower than the reference temperature, the rising time of the last sustain pulse is selected to be short S4. On the contrary, if the measured temperature is higher than the reference temperature, the rising time of the last sustain pulse is selected to be long S5. If the reference temperature is not greater than the reference temperature in operation S3 (after having been determined to not be lower than the reference temperature in operation S2), the rising time of the last sustain pulse is selected to be the same as the rising time of the previous sub-field S6. The reference temperature may be set to a temperature range corresponding to an atmospheric temperature (i.e., about 15 to 25° C.).

According to the driving device and method of the PDP according to an exemplary embodiment, if the temperature of the PDP and the peripheral temperature (i.e., of the peripheral parts of the PDP) is low, the rising time of the last sustain pulse applied in the sustain period is selected to be short thereby preventing an over discharge from being generated for the following sustain period. More particularly, a volume of the space charges and momentum thereof is reduced when the sustain discharge occurs at the low temperature so that a relatively small number of wall charges is formed. If the rising time of the last sustain pulse is selected to be short, a number of wall charges formed in the discharge cell during the sustain discharge is increased, so that the reset discharge of the next reset period occurs relatively strongly. Consequently, the address discharge is normally performed for the following address period thereby preventing the sustain discharge from being over-discharged.

On the contrary, if the temperature of the PDP and the peripheral temperature of the peripheral parts of the PDP is high, the rising time of the last sustain pulse applied in the sustain period is selected to be long thereby preventing a low discharge from occurring for the next sustain period. More particularly, a volume of space charges and momentum thereof generated in the case of a discharge that is large at a high temperature in comparison with the reference temperature, thereby forming a relatively large number of wall charges, is formed for the sustain period. If the rising time of the last sustain pulse is selected to be long, the number of wall charges generated in the discharge cell decreases in case of the sustain discharge so that the reset discharge for the following reset period occurs relatively weakly. Consequently, the address discharge is normally performed for the following address period thereby preventing the sustain discharge from being low-discharged.

The sustain pulse used in an exemplary embodiment of the present invention may be selected as the same driving pulse used in an exemplary embodiment of the present invention, however another driving pulse may be used. In this time, the driving pulse may be selected so as to change the rising time of the last sustain pulse applied in the sustain period according to a gray scale of respective sub-fields.

As described above, a low discharge and an over discharge can be prevented from occurring in the sustain period of a next sub-field by gradually changing the rising time of the last sustain pulse applied in the sustain period in respective sub-fields.

In addition, the rising time of the last sustain pulse applied in the sustain period is controlled according to a temperature the PDP and a peripheral temperature of the peripheral parts of the PDP to thereby prevent an over discharge at the low temperature and a low discharge at the high temperature.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A driving method of a plasma display panel, comprising:
dividing one frame into a plurality of sub-fields, each of the sub-fields comprising:
a reset period in which charges present in a discharge cell of the plasma display panel are decreased,
an address period in which a discharge cell of the plasma display panel is selected to be discharged, and
a sustain period in which the discharge cell of the plasma display panel selected to be discharged is discharged, and
controlling a rising time of a last sustain pulse applied in the sustain period of a first sub-field to the discharge cell of the plasma display panel selected to be discharged differently from a rising time of a last sustain pulse applied in the sustain period of a second sub-field.

2. The driving method of claim 1, wherein the controlling of the rising time comprises:
controlling a rising time of a last sustain pulse applied in a sub-field of the plurality of sub-fields according to a gray scale weight value.

3. The driving method of claim 2, wherein the controlling of the rising time further comprises:
decreasing the rising time of the last sustain pulse applied in the sub-field of the plurality of sub-fields if the gray scale weight value of the sub-field of the plurality of sub-fields is less than a predetermined gray scale weight value.

4. The driving method of claim 2, wherein the controlling of the rising time further comprises:
increasing the rising time of the last sustain pulse applied in the sub-field of the plurality of sub-fields if the gray scale weight value of the sub-field of the plurality of sub-fields is greater than a predetermined gray scale weight value.

5. The driving method of claim 1, wherein the controlling of the rising time comprises:
controlling a rising time of a last sustain pulse applied in a sub-field of the plurality of sub-fields in proportion to a number of sustain pulses applied in the sustain period of the sub-field of the plurality of sub-fields.

6. The driving method of claim 5, wherein the controlling of the rising time further comprises:
increasing the rising time of the last sustain pulse applied in the sustain period in the sub-field of the plurality of sub-fields in proportion to the number of the sustain pulses applied in the sustain period in the sub-field of the plurality of sub-fields.

7. The driving method of claim 5, wherein the controlling of the rising time further comprises:
decreasing the rising time of the last sustain pulse applied in the sustain period in the sub-field of the plurality of sub-fields in proportion to the number of the sustain pulses applied in the sustain period in the sub-field of the plurality of sub-fields.

8. The driving method of claim 1, further comprising:
controlling the dividing of one frame into a plurality of sub-fields to change a gray scale of the discharge.

9. The driving method of claim 8, wherein the controlling of the dividing further comprises:
increasing a number of sub-fields into which the one frame is divided so as to change the gray scale from a low level to a high level.

10. The driving method of claim 9, wherein the controlling of the dividing further comprises:
decreasing the rising time of a last sustain pulse applied in a sustain period of a sub-field of the plurality of sub-fields.

11. The driving method of claim 1, further comprising:
determining a temperature of the plasma display panel; and
controlling a rising time of a last sustain pulse applied in a sustain period of a sub-field of the plurality of sub-fields according to the determined temperature.

12. A driving method of a plasma display panel, comprising:
dividing one frame into a plurality of sub-fields, each of the sub-fields comprising:
a reset period in which charges present in a discharge cell of the plasma display panel are decreased,
an address period in which a discharge cell of the plasma display panel is selected to be discharged, and
a sustain period in which the discharge cell of the plasma display panel selected to be discharged is discharged, and
controlling a rising time of a last sustain pulse applied in the sustain period of a first sub-field to the discharge cell of the plasma display panel selected to be discharged differs from a rising time of a last sustain pulse applied in the sustain period of a second sub-field according to a temperature of the plasma display panel.

13. The driving method of claim 12, wherein the controlling of the rising time of the last sustain pulse comprises:
decreasing the rising time if the temperature of the plasma display panel is lower than a reference temperature; and
increasing the rising time if the temperature of the plasma display panel is higher than the reference temperature.

14. A driving apparatus of a plasma display panel including a plurality of first electrodes, a plurality of second electrodes, and a plurality of address electrodes, the driving apparatus comprising:
a controller to divide one frame into a plurality of sub-fields, each of the sub-fields comprising:
a reset period in which charges present in a discharge cell of the plasma display panel are decreased,
an address period in which a discharge cell of the plasma display panel is selected to be discharged, and
a sustain period in which the discharge cell of the plasma display panel selected to be discharged is discharged; and
a driver to apply a sustain pulse to the first and second electrodes in the sustain period,
wherein a rising time of a last sustain pulse applied in the sustain period of a first sub-field to the discharge cell of the plasma display panel selected to be discharged differs from a rising time of a last sustain pulse applied in the sustain period of a second sub-field.

15. The driving apparatus of claim 14, wherein a rising time of the last sustain pulse applied in a sustain period of a sub-field of the plurality of sub-fields is selected to be short if a gray scale of the sub-field is less than a predetermined gray scale.

16. The driving apparatus of claim 14, wherein a rising time of the last sustain pulse applied in a sustain period of a sub-field of the plurality of sub-fields is proportional to a number of the sustain pulses applied in the sustain period of the sub-field of the plurality of sub-fields.

17. The driving apparatus of claim 14, wherein the controller divides the one frame into a plurality of sub-fields to change a gray scale of the discharge.

18. The driving apparatus of claim 17, wherein controller divides the one frame into a plurality of sub-fields to change the gray scale of the discharge to sequentially increase the gray scale of the discharge from a low level to a high level

19. The driving apparatus of claim 14, further comprising:
a temperature sensor to measure a temperature of the plasma display panel and a peripheral temperature of the plasma display panel.

20. The driving apparatus of claim 19, wherein the controller selects a rising time of a last sustain pulse to be short if the temperature measured by the temperature sensor is lower than a reference temperature, and the controller selects the rising time of the last sustain pulse to be long if the measured temperature is higher than the reference temperature.
